(19) United States
(12) Patent Application Publication
(10) Pub. No.: US 2025/0086972 A1
(43) Pub. Date: Mar. 13, 2025

(54) METHOD AND SYSTEM OF REDUCING DRIVEWAY COLLISIONS FOR DELIVERY/SERVICE VEHICLES

(71) Applicant: Nicholas Benedict, Kalamazoo, MI (US)

(72) Inventor: Nicholas Benedict, Kalamazoo, MI (US)

(21) Appl. No.: 18/244,991

(22) Filed: Sep. 12, 2023

(51) Int. Cl. G06V 20/50; G06N 3/09; G06Q 10/083; G06V 10/774; G06V 10/82; G06V 20/13; G06V 20/17

(52) U.S. Cl. CPC G06V 20/50; G06N 3/09; G06Q 10/083; G06V 10/774; G06V 10/82; G06V 20/13; G06V 20/17

(57) ABSTRACT

Methods and systems for evaluating driveway risk to reduce collision occurrences on driveways include obtaining a route comprising addresses, obtaining image data associated with each address, analyzing the image data to determine a level of risk associated with driving on the driveway at each address, and displaying the addresses and associated risks on a display panel of a vehicle.

### FIELD OF THE DISCLOSURE

The present disclosure pertains to commercial vehicle safety, and more particularly to methods and systems for reducing collisions and resulting damage in driveways.

### BACKGROUND OF THE DISCLOSURE

It has been determined that the majority of collisions and monetary damage for package delivery vehicles (delivery vans) occurs in driveways. It is suspected that the same is likely the case for service vehicles, such as service utility vehicles used by plumbers, electricians, and the like.

There is a greater propensity for collisions on certain driveways, such as those that are narrow or have a particularly narrow section; curvy driveways, especially those with sharp curves; driveways that do not permit the driver to turn around; driveways having low overhanging tree limbs or other obstructions; driveways with relatively steep grades; etc. In such cases, it may be desirable to walk the driveway to a delivery location (e.g., a building porch) rather than drive the delivery vehicle to the delivery location. In certain cases, such as when a driveway does not have room to turn a delivery vehicle around, but otherwise is free of high risk characteristics, it may be advisable to back the delivery or utility vehicle down the driveway.

A driver can rely on his or her own judgment in those cases where a driveway is relatively short and straight, without visual obstructions. However, for longer driveways and driveways with curves and/or visual obstructions, a driver's experience and judgment are significantly less likely to be a reliable predictor of collision risks. In order to optimize the balance between delivery time and collision risk avoidance, it is most desirable to drive forward down every driveway that is free of high risk characteristics, drive backwards down longer driveways that do not allow a driver to turn the delivery/service vehicle around and that are otherwise free of high risk characteristics, and to walk down those driveways where the risk of collision is determined to be unacceptably high.

It would be highly desirable to provide delivery and service vehicle drivers a more reliable prediction of the collision risk associated with a driveway associated with an address at which a package delivery or service is being provided.

### SUMMARY OF THE DISCLOSURE

Described are methods and systems for reducing driveway collision risk for a delivery or service vehicle while also promoting time efficiency.

The methods involve obtaining a delivery or service route or schedule comprising a plurality of scheduled delivery or service addresses, obtaining aerial, satellite, and/or street images of a property associated with each address on the route, analyzing the aerial, satellite and/or street images of the property to evaluate and/or grade (score) a risk associated with driving the delivery or service vehicle down a driveway on the property, and displaying on a display panel on-board the delivery or service vehicle the address and associated collision risk grade.

The system may comprise a processor programmed with software configured to grade driveway collision risk at an address based on aerial, satellite and/or street-view images, a modem or transceiver for requesting and receiving a delivery or service route and image data for a property associated with an address on the delivery or service route, and a display panel on-board a delivery or service vehicle for displaying a delivery or service address and an associated driveway collision risk grade.

### BRIEF DESCRIPTION OF THE DRAWINGS

FIG. 1 is a process flow diagram for reducing driveway collision risk.

### DETAILED DESCRIPTION

The methods and systems disclosed herein utilize a trained machine-learned model to identify driveway collision risk features within imaging data of a driveway on a property associated with an address to which a package or other services is to be delivered. The imaging data may include aerial images and/or satellite images, and could also include street-view imaging data, LIDAR data, infrared image data, user-provided images, etc. The identified driveway collision risk features can be used to determine a collision risk grade (score or index) associated with driving a particular vehicle (e.g., a delivery van) down or along a particular driveway.

The trained machine-learned model is trained from image data for each of a plurality of addresses, wherein each address is provided with an associated driveway collision risk grade. The grades used in the training data set can be, and generally are, provided by delivery drivers and/or other humans experienced at evaluating driveway collision risks based on image data and/or on-site determinations. The model can be developed, at least in part, from historical collision event data, when available.

Driveway collision risk features can be defined based on known correlations between driveway characteristics and driveway collision propensity. For example, there may be known or justifiably anticipated correlations between collision propensity and driveway width; trees, or other potential obstructions in close proximity to an edge of a driveway; vehicles parked in the driveway, small radius curves, etc.

An Artificial Neural Network (ANN) or other form of Artificial Intelligence (AI) can be employed to develop an accurate model for predicting a driveway collision risk grade from pre-graded (i.e., pre-labeled) image data for a property associated with a package or service delivery address. The resulting model provides a form of computer vision in which images (e.g., aerial, satellite, and/or street-view images) can be analyzed for characteristics indicative of the driveway collision risk grade. The model can also take into consideration statistical data correlating collision occurrences with driveway characteristics, when available.

The collision risk grading system can involve only two grade levels, such as a low risk grade, indicating that a van driver may proceed down a driveway to deliver a package, and a high risk grade, indicating that a van driver should not proceed down a driveway, and should instead walk down the driveway to deliver a package. A grading system can, for example, include a third grade level, such as a medium risk grade, indicating that a van driver can back the delivery van down the driveway, but should not enter in the forward direction. More grade levels are also possible if desired or determined advantageous.

The methods and systems described herein are primarily targeted for use in the package delivery services industry. However, other possible industries that could benefit from applications of the methods and systems described herein include snow removal services and certain construction services, such as to determine the types and sizes of vehicles that can be used on a driveway.

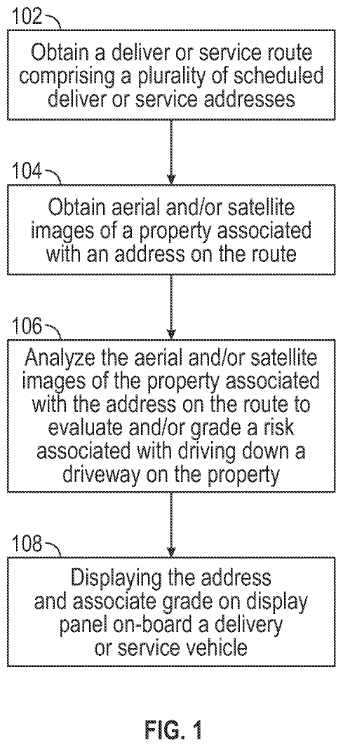

An exemplary process is illustrated in FIG. 1. In a first step 102, a delivery or service route or schedule comprising a list of addresses for package or service deliveries is provided. The list is preferably organized to minimize travel time and/or travel distance. The delivery or service schedule or route is preferably provided to a processor programmed with software configured to grade driveway collision risk at an address based on image data. The processor can be in a computing device located in a delivery or service vehicle, in a fixed location, or a portable (e.g., handheld) device. In a second step 104, image data for each address in the delivery or service schedule or route is obtained. Such data can include aerial images, satellite images, and/or street-view images. Such data can be held in a private data storage unit (e.g., a computer hardware or server) or can be accessed from publicly available data storage via the internet. In a third step 106, the image data is analyzed to determine an appropriate driveway collision risk grade for each address listed in the schedule or route. In step 108, the addresses and corresponding collision risk grade are displayed to the driver of the package or service delivery vehicle, such as on a display panel mounted in the vehicle or on a display of a handheld device.

In certain embodiments, the processor is located in the delivery vehicle, with the processor preferably being provided with a transceiver (e.g., 5G communications adaptor) for accessing a global network (cloud). The processor can be provided with memory for storing data, particularly the addresses in the route and the corresponding driveway collision risk grade.

In some embodiments, a main processor can be at a fixed location, and used to obtain the image data and calculate the driveway collision risk grades; and a secondary processor can be provided in the delivery vehicle or on a handheld device (carried by the driver of the delivery vehicle) to receive the addresses and grades from the primary processor.

While the disclosed methods and systems are described herein with reference to an illustrated embodiment, it should be understood that the methods and systems are not limited hereto. Those having ordinary skill in the art and access to the teachings herein will recognize additional modifications and embodiments within the scope thereof. Therefore, the disclosed methods and systems are limited only by the claims attached herein.

1. A computer-implemented method of reducing a risk of collision of a delivery or service vehicle in a driveway, comprising:
providing a main processor programmed with software configured to grade driveway collision risk at an address from an aerial or satellite image;
obtaining a delivery route comprising a list of delivery addresses;
obtaining image data for a property associated with an address on the delivery route;
using the software to analyze the aerial or satellite image of the property associated with the address on the delivery route to grade the risk of driving the vehicle along a driveway extending from a street toward a building on the property; and
notifying a driver of the vehicle of the graded risk.

2. The method of claim 1, wherein the main processor is located in the vehicle.

3. The method of claim 2, wherein the main processor is provided with a transceiver for accessing remotely stored delivery route information via a wireless network, and for accessing aerial or satellite images.

4. The method of claim 3, wherein the main processor is provided with memory for storing the delivery route information received by the transceiver.

5. The method of claim 1, wherein the main processor is provided with a display of displaying the addresses in the delivery route and the associated grading of the risk of driving the vehicle along the driveway associated with each address.

6. The method of claim 1, wherein the main processor is located remotely from the vehicle, and the vehicle is provided with secondary processor configured to receive from the main processor, the addresses in the delivery route and the associated grading of the risk of driving the vehicle along the driveway associated with each address.

7. The method of claim 6, wherein the secondary processor is provided with memory for storing the delivery route information and the grade associated with each address in the delivery route, and a display for displaying the addresses and associated grades for each address on the route.

8. The method of claim 1, wherein the software comprises a computer implemented algorithm for risk grading of driveways obtained by:
developing a training data set in which a plurality of images for a plurality of associated properties are graded for collision risk of driving the vehicle along a driveway extending from a street toward a building on the property; and
developing the algorithm from the training data set using a neural network.

9. The method of claim 8, wherein the risk grade of driving the vehicle along a driveway for each image in the training set are determined by a human based on the image data.

10. A system for reducing a risk of collision of a delivery or service vehicle in a driveway, comprising:
a vehicle-mounted processor programmed with software configured to grade driveway collision risk at an address from image data;
a transceiver connected with the processor for receiving a delivery route comprising a list of delivery addresses, and for receiving image data for an address on the delivery or service route; and
a display connected with the processor for displaying the addresses and associated risk grades to a driver of the vehicle.

11. The system of claim 10, wherein the software comprises a computer implemented algorithm for risk grading of driveways obtained by:
developing a training data set in which an image data for a plurality of associated properties are graded for collision risk of driving the vehicle along a driveway extending from a street toward a building on the property; and
developing the algorithm from the training data set using a neural network.

12. The system of claim 11, wherein the risk grade of driving the vehicle along a driveway for each address in the training set is determined by a human based on the image data.

13. A system for reducing risk of collision of a delivery or service vehicle in a driveway, comprising:
a main processor located remotely from the vehicle, the main processor programmed with software configured to grade driveway collision risk at an address from image data;
a secondary processor located in the vehicle and configured to receive, from the main processor, a delivery route comprising a list of delivery addresses and associated driveway collision risk grades developed by the software;
a memory connected with the secondary processor for storing the delivery addresses and associated driveway collision risk grades; and
a display connected with the processor for displaying the addresses and associated risk grades to a driver of the vehicle.

14. The system of claim 13, wherein the software comprises a computer implemented algorithm for risk grading of driveways obtained by:
developing a training data set in which a plurality of image data for a plurality of associated properties are graded for collision risk of driving the vehicle along a driveway extending from a street toward a building on the property; and
developing the algorithm from the training data set using a neural network.

15. The system of claim 14, wherein the risk grade of driving the vehicle along a driveway for each address in the training set are determined by a human from the image data.

16. A computer-implemented method of evaluating driveway collision risk, comprising:
receiving imaging data for a property associated with a delivery address, wherein the imaging data includes driveway imaging data at the property;
extracting by a machine-learned model, driveway collision risk features for the driveway;
determining, by the machine-learned model and the driveway collision risk features, a driveway collision risk grade for the driveway; and
providing a representation of the driveway collision risk grade associated with the delivery address for display.
